(19) United States
(12) Patent Application Publication
(10) Pub. No.: US 2008/0273267 A1
(43) Pub. Date: Nov. 6, 2008

(54) Slider with improved structure for adjusting flying height thereof and hard disk drive with the same

(75) Inventor: Anthony Wai Yuen Lai, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/797,142

(22) Filed: May 1, 2007

(51) Int. Cl. G11B 5/60

(52) U.S. Cl. 360/234.5

(57) ABSTRACT

A slider has a slider substrate, a read sensor, a top shield and a bottom shield sandwiching the read sensor, and a write shield. The slider substrate is electrically connected to a substrate electrical connection which is adapted to provide a flying height control voltage to the slider substrate for realizing EFH control so that the bottom shield and the write shield both are electrically connected to a ground electrical connection to eliminate pits on shields of the slider as well as reduce electrostatic discharge (ESD) damage and noise during EFH operation. The slider also employs a bottom plate, a heater and a shunting circuit with shunting resistances to optimum reading and/or writing performance by further better preventing noise, cross-talk and ESD. The present invention also discloses a hard disk drive with the slider for adjusting the slider's flying height.

### FIELD OF THE INVENTION

The present invention relates generally to magnetic data storage drives. In particular, this invention relates to structures for adjusting flying height of slider over magnetic storage media, and more specifically, the present invention relates to structures for flying height control as well as protecting read sensor and write pole of the slider from noise interference and electrostatic discharge.

### BACKGROUND OF THE INVENTION

Disk drives are widely used in computers, consumer electronics and data processing systems for storing information in digital form. The disk drive typically includes a series of rotatable storage disks, or other magnetic storage mediums and head stack assemblies. Each head stack assembly includes a slider having a read/write head that transfers information to and from the storage disk. The read/write head, commonly known as transducer, is typically carried by and embedded in the slider, and the slider is held in a closer relative position over discrete data tracks formed on the disk to permit a read or write operation to be carried out. In order to properly position the transducer with respect to the disk surface, an air bearing surface (ABS) formed on the slider experiences a fluid air flow that provides sufficient lift force to fly the slider with the transducer above the disk data tracks. The air flow is generated by high speed rotation of the magnetic disk which accordingly drives the air flow along its surface in a direction substantially parallel to the tangential velocity of the disk. The air flow cooperates with the ABS of the slider which enables the slider to fly above the spinning storage disk. That is, the rotation of the storage disk causes the slider to ride a distance “h” from the storage disk relative to the ABS of the slider. The distance “h” is referred to as the flying height or separation gap between the ABS and the spinning storage disk and represents the position that the slider assembly occupies when the storage disk is rotating during normal operation of the disk drive.

At present, each storage disk includes one or two disk surfaces that are divided into a plurality of narrow, annular regions of different radii, commonly referred to as data tracks. The number of tracks per radial inch (TPI) on the storage disk is known as track density. Digital information is recorded on the data tracks in the form of magnetic transitions or bits using the read/write head. The number of bits per inch (BPI) along the track is known as linear density. Areal density is necessarily increasing in an effort to raise the storage capacity of the disk drive, while maintaining a fixed or lower manufacturing cost of the drive.

For a given linear density, a target head-to-disk spacing is required to ensure accurate data transfer. Unfortunately, consistent head-to-disk spacing during data transfer is difficult to achieve due to the constant changing environment. Further, the flying height of the slider is viewed as one of the most critical parameters affecting the reading and recording capabilities of a mounted read/write head. A large variation in flying height from slider to disk can cause significant issues in reliability of the disk drives. In other words, an invariable flying height allows the transducer to achieve greater resolution between different data bit locations on the disk surface, thus improving data density and storage capacity. If the flying height deviates positively and significantly from the target flying height, the head-to-disk spacing may become too large and may cause unreliable reading from and writing to the storage disk. Conversely, if the flying height deviates negatively and significantly from the target flying height, the head may contact the surface of the storage disk.

In addition, with the increasing popularity of lightweight and compact notebook type computers that utilize relatively small yet powerful disk drives, the need for progressively lower flying height has continually grown. Some of the major objectives are to fly the slider and its accompanying transducer as close as possible to the surface of the rotating disk, and to uniformly maintain that constant close distance regardless of variable flying conditions. Hence, some mechanism to control the flying height of the slider has raised.

One approach that has been effectively used by disk drive manufacturers to proceed the positional control of slider is dynamic flying height (DFH) control, which employs a thermal actuator or heater to adjust the height between the slider and the disk through thermal expansion of the slider. With such mechanism, the flying height has well controlled. However, in fact, such mechanism is not effective because its response time is slow.

At present, some manufacturers utilize another mechanism called electrical flying height (EFH) control. This mechanism applies an electrostatic actuator between the disk and the slider to actively adjust the flying height by electrical attraction with low cost, low mass and low power consumption as well as 50% faster actuation efficiency than the conventional DFH control. Specially, referring to FIG. 1, the electrostatic actuator comprises a first actuator electrode 611 provided by a transducer 610 of slider 600 and isolated from a substrate 620 of the slider 600 as well as a disc 500, which acts as a second actuator electrode with an effective area equal to that of the first actuator electrode. The first actuator electrode 611 acts as a first capacitor plate, and the second electrode that faces the first capacitor plate acts as a second capacitor plate. The two capacitor plates are separated by an air gap, that is, the flying height spacing, and are electrostatically attracted to one another when a control signal is applied to an electrical connection 700. When a high potential voltage is applied to the electrodes via the electrical connection 700, the air gap will be reduced due to an electrical attraction between the two electrodes, and vice versa. However, the present EFH design may induce many pits on shields due to high potential on shields within the transducer 610 during EFH operating and cause electrostatic discharge (ESD) potential hazard to a read sensor and a write pole of the transducer 610 because the transducer 610 which provides the first actuator electrode 611 is not grounded but charged.

In light of the above, the need exists to provide an improved EFH control structures that allow for precise adjustment for the slider's flying height as well as protecting read sensor and write pole of the slider from noise interference and electrostatic discharge.

### SUMMARY OF THE INVENTION

Accordingly, an object of the present invention is to provide a slider with a slider substrate being applied a control voltage thereto for realizing EFH control while shields of the slider being simultaneously grounded thereby pits do not appear on the shields and ESD is eliminated.

A further object of the present invention is to provide a hard disk drive for adjusting flying height of a slider which applies a control voltage to a slider substrate of the slider for realizing EFH control while simultaneously grounds shields of the slider thereby pits do not appear on the shields and ESD is eliminated.

To achieve the above-mentioned objects, the present invention provides a slider adapted for controlling flying height thereof with respect to an electrically conductive storage medium. The slider comprises a slider substrate having an ABS configured to face the storage medium, a top shield and a bottom shield sandwiching a read sensor, and a write shield. The slider substrate is electrically connected to a substrate electrical connection which is adapted to provide a flying height control voltage to the slider substrate. Thus the slider substrate and the storage medium form two plates of a capacitor separated by a dielectric layer of air supporting the slider. The bottom shield and the write shield both are electrically connected to a ground electrical connection.

As an embodiment of the present invention, the slider further comprises a heater. An end of the heater electrically connects to the substrate electrical connection which is adapted to provide a flying height control voltage to the heater, and the other end of the heater electrically connects to the ground electrical connection.

As another embodiment of the present invention, the slider further comprises a bottom plate which is electrically connected to the ground electrical connection, and the top shield is electrically connected to the ground electrical connection.

As still another embodiment of the present invention, a shunting resistance is connected between the ground electrical connection and each of the write shield, the top shield and the bottom shield.

Preferably, the value of the shunting resistance between the ground electrical connection and either of the bottom shield and the top shield is selected from 10 k Ohm to 10M Ohm. Also preferably, the value of the shunting resistance between the ground electrical connection and the write shield is less than 10 Ohm.

Preferably, the value of the shunting resistance between the ground electrical connection and either of the bottom shield and the top shield equals to 2M Ohm.

A hard disk drive for adjusting flying height of a slider of the present invention comprises a storage medium and the slider. The slider comprises a slider substrate having an ABS configured to face the storage medium, a top shield and a bottom shield sandwiching a read sensor, and a write shield. The slider substrate is electrically connected to a substrate electrical connection which is adapted to provide a flying height control voltage to the slider substrate. Thus the slider substrate and the storage medium form two plates of a capacitor separated by a dielectric layer of air supporting the slider. The bottom shield and the write shield both are electrically connected to a ground electrical connection.

In comparison with the prior art, the present invention imposes a flying height control voltage to the slider substrate, thus to realize EFH control. Therefore, shields of the slider are allowed to be grounded, and accordingly the slider can successfully eliminate pits on the shields and soundly suppress ESD in the slider.

Alternatively, the slider of the present invention also applies a bottom plate, a heater and a shunting circuit with shunting resistances to optimum reading and/or writing performance by further better preventing noise and cross-talk as well as ESD.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 illustrates a hard disk drive of a conventional approach, in which potential voltage is applied to an actuator electrode positioned on a transducer of a slider of the system for adjusting the slider's flying height;

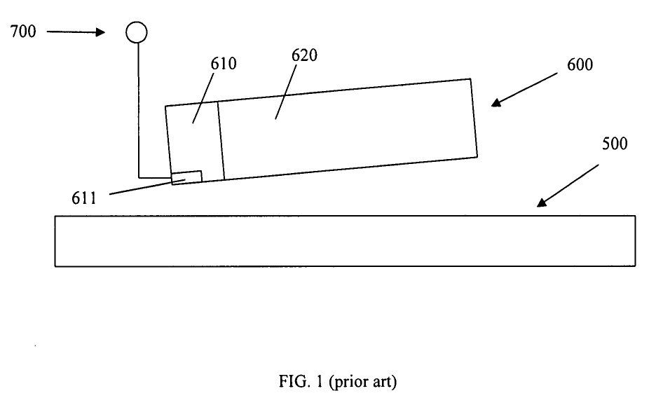

FIG. 2 illustrates a hard disk drive according to the present invention, in which a flying height control voltage is applied to a substrate of a slider of the hard disk drive for adjusting the slider's flying height;

FIG. 3 is a schematic cross-sectional view of a slider of a first embodiment of the hard disk drive shown in FIG. 2;

FIG. 4 is a schematic ABS plane view of the slider shown in FIG. 3;

FIG. 5 is a schematic ABS plane view of a slider of a second embodiment according to the present invention, in which a bottom plate is introduced to be grounded;

FIG. 6 is a schematic cross-sectional view of the slider shown in FIG. 5;

FIG. 7 is a schematic ABS plane view of a slider of a third embodiment according to the present invention, in which a heater is introduced to control the slider's DFH;

FIG. 8 is a schematic ABS plane view of a slider of a fourth embodiment according to the present invention, in which a shunting circuit with shunting resistances is introduced to prevent noise and cross-talk; and

FIG. 9 is a schematic ABS plane view of a slider of a fifth embodiment according to the present invention, in which a bottom plate, a heater and a shunting circuit with shunting resistances are introduced to optimum reading and/or writing performance of the slider.

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a slider with a slider substrate being applied a flying height control voltage thereto and shields being grounded. Such design enables the slider of the present invention to realize EFH control and to eliminate pits on shields of the slider and ESD in the slider while simultaneously achieving noise immunity. Alternatively, the slider of the present invention can introduce a bottom plate, a heater or a shunting circuit with shunting resistances to optimum reading and/or writing performance by further better preventing noise and cross-talk and ESD.

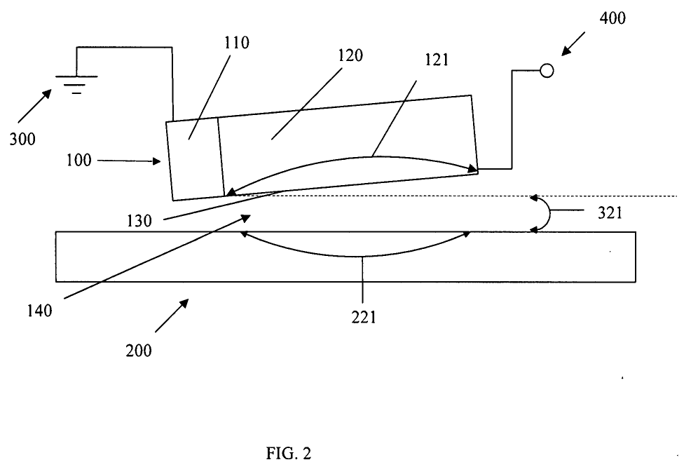

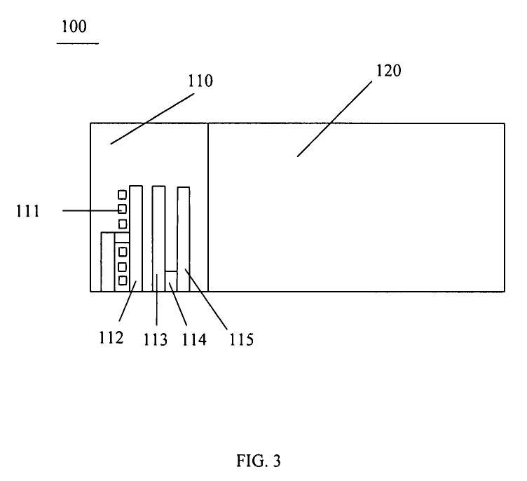

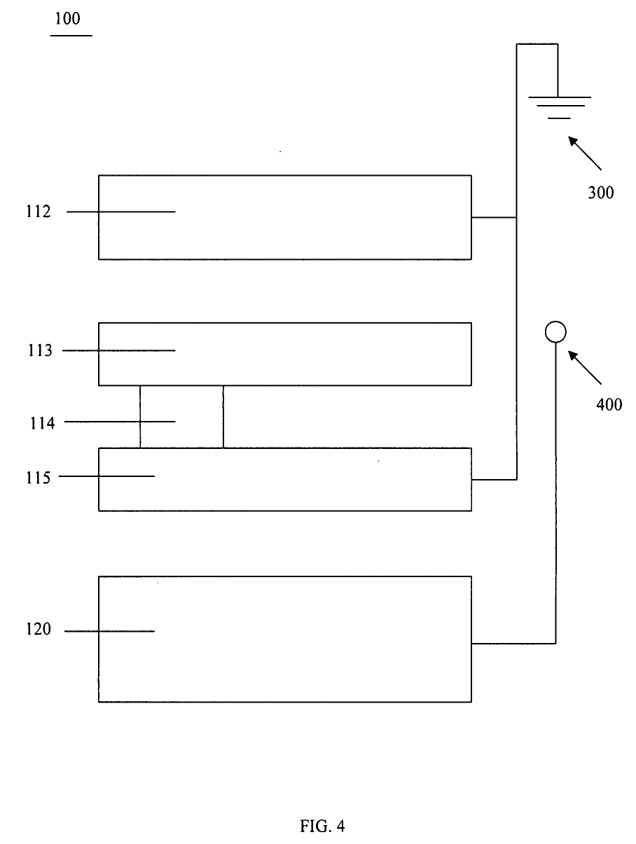

FIG. 2 illustrates a hard disk drive for adjusting flying height of a slider with respect to an electrically conductive storage medium according to the present invention. FIG. 3 is a schematic cross-sectional view of a slider of a first embodiment of the hard disk drive shown in FIG. 2. FIG. 4 is a schematic ABS plane view of the slider shown in FIG. 3.

Referring to FIG. 2, the hard disk drive comprises a disk 200 and a slider 100 carried above the disk 200. The disk 200 is magnetic and optically readable material. The hard disk drive employs the slider 100 for injecting and/or extracting signals from an electrically conductive surface of the disk 200. The disk 200 and the slider 100 are separated by flying height spacing 140. In this embodiment, a dielectric layer (herein an air gap) of the flying height spacing 140 between the slider 100 and the disk 200 supports the slider 100 above the disk 200. The slider 100 flies over the disk 200 at a flying height defined by the flying height spacing 140 which is actively and electrically controlled by an electrode 121 as explained in more detail below.

The slider 100 consists of a transducer 110 and a substrate 120. The transducer 110 has a read sensor 114 and a write coil 111. The read sensor 114 is typically protected from stray electromagnetic fields during operation by a top shield 113 and a bottom shield 115. The write coil 111 is typically an inductive coil with a write shield 112. The slider substrate 120 has an ABS 130 configured to face the electrically conductive surface of the disk 200. The structure of the top shield 113, the bottom shield 115 and the read sensor 114 are sequentially formed on the slider substrate 120.

The slider substrate 120 is electrically connected to a substrate electrical connection 400 which is adapted to provide a flying height control voltage to the slider substrate 120. The interface between the slider substrate 120 and the electrically conductive media surface of the disk 200, that is, the dielectric layer of the flying height spacing 140, enables the slider substrate 120 and the electrically conductive media surface to be modeled as a quasi-parallel capacitor 321. The slider substrate 120 and the electrically conductive media surface respectively form two opposing plates of the capacitor 321. More particularly, the slider substrate 120 acts as a first capacitor plate or first flying height control electrode 121 electrically separated from the transducer 110 by the bottom plate 116. The electrically conductive media surface of the disk 200 that faces the first capacitor plate functions as a second capacitor plate or a second flying height control electrode 221, which has an effective area equal to that of the first flying height control electrode 121. In this embodiment, the first capacitor plate 121 and the second capacitor plate 221 join together to realize EFH control.

The following paragraph explains principles of the EFH control of the subject slider 100 with respect to the disk 200 of this invention. When the flying height control voltage, which can be kept below certain levels to actively adjust the flying height spacing 140, is applied to the slider substrate 120 via the substrate electrical connection 400, a difference in electrical potential, which developed from a control voltage signal generated by the flying height control voltage, occurs between the first capacitor plate 121 and second capacitor plate 221, thus producing an electrostatic attractive force between the slider substrate 120 and the disk 200. The electrostatic attractive force will induce the first flying height control electrode 121 to be electrostatically attract to the second flying height control electrode 221 and accordingly shift the distance between the slider 100 and the disk 200, thus realizing adjusting the slider's flying height.

By acting as the quasi-parallel capacitor 321 during EFH operation, the amount of spacing in the head-disk interface (FIDI), that is the flying height spacing 140, may be increased or decreased based on the amount of control voltage applied. Specifically, the distance between the slider 100 and the disk 200 will decrease with increasing applied voltage, as the slider is driven by increased electrostatic attractive force between the first capacitor plate 121 and second capacitor plate 221 at high voltage. In other words, applying a control voltage may decrease the flying height spacing 140, thus achieve the purpose of electrostatically adjusting the flying height spacing 140 to maintain flying height of the slider 100 at a desired set point.

In the embodiment, the write shield 112 and the bottom shield 115 are both electrically connected to a ground electrical connection 300 which is grounded. In this case, charge only builds up on the slider substrate 120 because shield potential is the same as ground during EFH operation, thus pits will not appear at shields of the transducer 110. In addition, ESD potential hazard is eliminated and noise immunity is well achieved because of the grounded internal shunting circuit consisting of write shield grounding and the bottom shield grounding.

Alternatively, the slider of the present invention can be designed to possess some optimized structure. Such design will achieve optimal noise and cross-talk rejection and produce both the noise-rejection characteristics and the ESD protection while simultaneously achieving EFH control, which will be illustrated below.

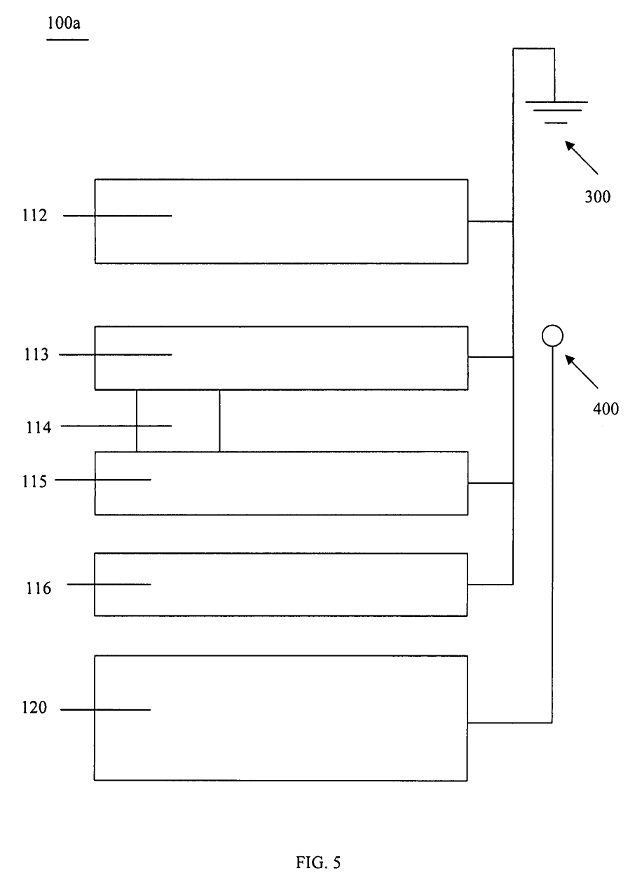

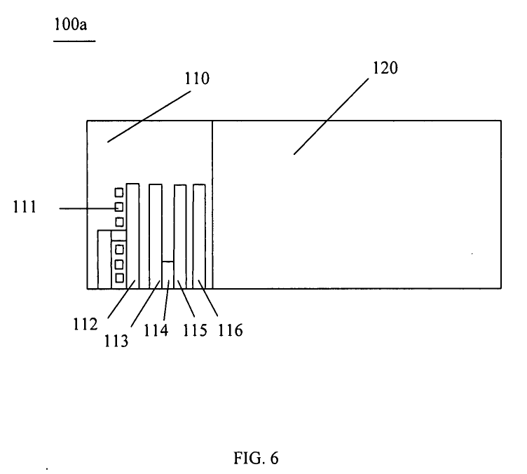

FIG. 5 is a schematic ABS plane view of a slider 100a of a second embodiment according to the present invention. FIG. 6 is a schematic cross-sectional view of the slider shown in FIG. 5. Comparing with the slider 100 of the first embodiment shown in FIG. 4, the slide 100a further has a bottom plate 116, and the bottom plate 116 as well as the top shield 113 are respectively and electrically connected to the ground electrical connection 300 for coupling noise thereby achieving noise compensation effect, thus further improving the slider's performance.

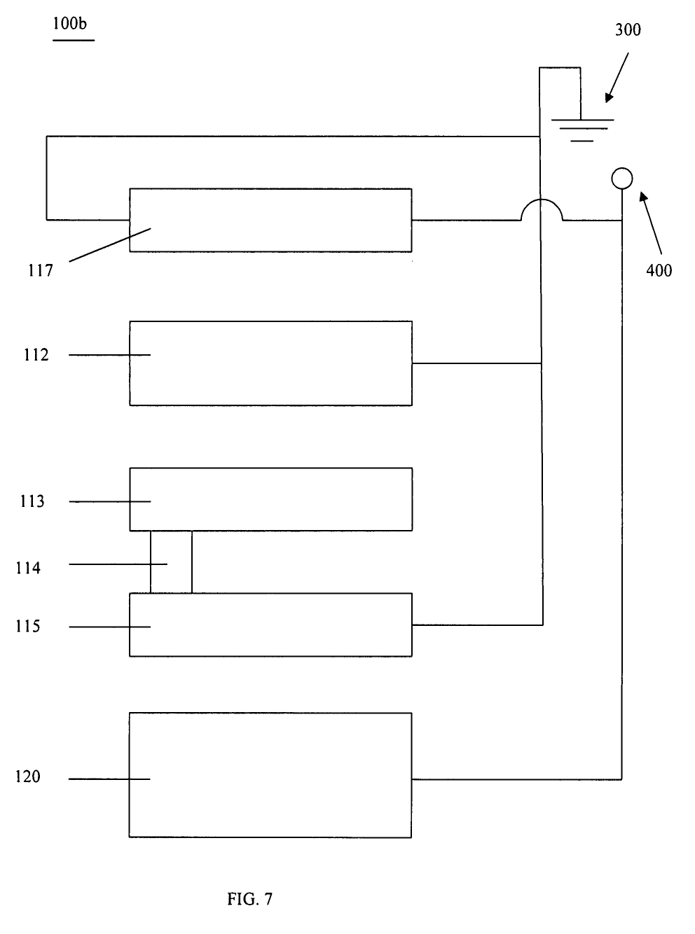

FIG. 7 is a schematic ABS plane view of a slider 100b of a third embodiment according to the present invention. Comparing with the slider 100 of the first embodiment shown in FIG. 4, the slide 100b further has a heater 117. The heater 117 is used to generate heat and therefore cause a thermal expansion of the slider 100b to adjust the flying height. More specifically, one end of the heater 117 is electrically connected to a heater electrical connection (not shown) which is adapted to provide a flying height control voltage to the heater 117. The other end of the heater 117 is electrically connected to the ground electrical connection 300. In this embodiment, the heater electrical connection and the substrate electrical connection 400 are electrically connected to provide a centralized flying height control voltage for adjusting the slider's flying height. When the heater is actuated, a portion of the slider 100a in the vicinity thereof expands due to the heat produced by actuating the heater 117. This expansion causes the ABS to distort in a controlled manner so as to be closer to the surface of the disk. In this manner, the flying height can be controlled when desired, thus the slider 100a has higher reading and writing performance. In the embodiment, the heater 117 may be a coil structure of conductive material. Perfectly, the heater 117 is a conductor of relatively higher resistivity.

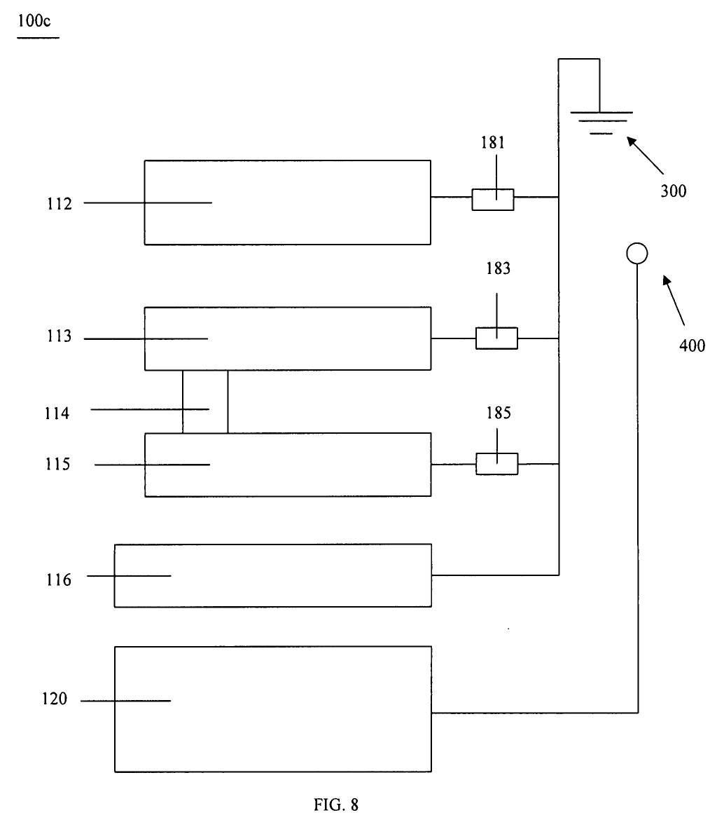

FIG. 8 is a schematic ABS plane view of a slider 100c of a fourth embodiment according to the present invention. Comparing with the slider 100a of the second embodiment, the slider 100c further has a shunting circuit with shunting resistances to form a current drainage path to better prevent ESD and eliminate noise. The shunting circuit includes a first shunting resistance 181 between the ground electrical connection 300 and the write shield 112, a second shunting resistance between the ground electrical connection 300 and the top shield 113, and a third shunting resistance 185 between the ground electrical connection 300 and the bottom shield 115. Such structure enables to bleed accumulated charge from the read sensor 114 and its surrounding elements to the ground before the amount of the accumulated charge is sufficient to initiate the discharge. In that way, the shunting circuit suppresses ESD in the slider while simultaneously prevents noise and cross talk between the read sensor 114 and the adjacent write coil 111. Preferably, the first shunting resistance 181 is a low electrical resistance, the value of which is less than 10 Ohm. Also preferably, the second shunting resistance 183 or the third shunting resistance 185 is a highly electrical resistance having a value approximately between 10 k Ohm and 10M Ohm. In the embodiment, the second shunting resistance 183 and the third shunting resistance 185 preferably equals to 2M Ohm.

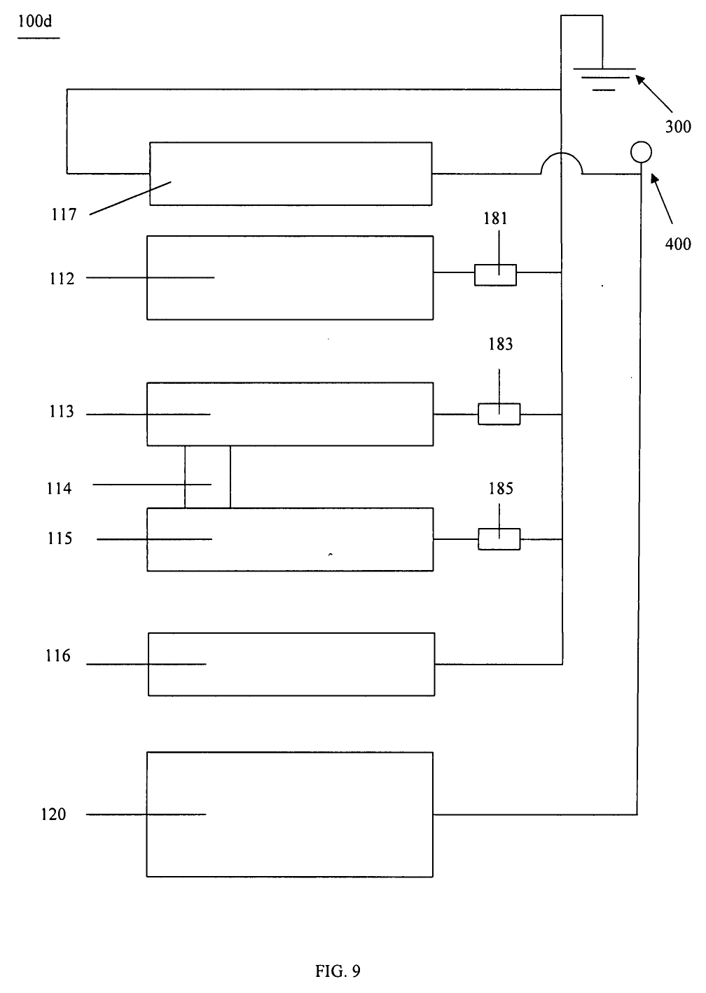

FIG. 9 is a schematic ABS plane view of a slider 100d of a fifth embodiment. Comparing with the slider 100c of the fourth embodiment shown in FIG. 8, the slider 100d further has a heater 117 for adjusting the slider's flying height using heat produced by the heater 117. In this embodiment, one end of the heater 117 is electrically connected to the substrate electrical connection 300 for providing a centralized flying height control voltage for adjusting the flying height of the slider 100e, and the other end of the heater 117 is electrically connected to the ground electrical connection 300.

Thus, the present invention provides, in various embodiments, an improved slider and associated hard disk drive for controlling flying height thereof with respect to an electrically conductive storage medium. The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, and to enable others skilled in the art to best utilize the invention and various embodiments with various modifications as are suited to the particular use contemplated. It is intended that the scope of the invention be defined by the claims appended hereto and their equivalents.

What is claimed is:

1. A slider adapted for controlling flying height thereof with respect to an electrically conductive storage medium, comprising:
a slider substrate having an air bearing surface configured to face the storage medium;
a top shield and a bottom shield sandwiching a read sensor; and
a write shield;
wherein the slider substrate is electrically connected to a substrate electrical connection which is adapted to provide a flying height control voltage to the slider substrate, whereby the slider substrate and the storage medium form two plates of a capacitor separated by a dielectric layer of air supporting the slider; and
wherein the bottom shield and the write shield both are electrically connected to a ground electrical connection.

2. The slider according to claim 1, further comprising a heater, wherein one end of the heater is electrically connected to the substrate electrical connection which is adapted to provide a flying height control voltage to the heater, and the other end of the heater is electrically connected to the ground electrical connection.

3. The slider according to claim 1, further comprising a bottom plate which is electrically connected to the ground electrical connection, and the top shield being electrically connected to the ground electrical connection.

4. The slider according to claim 3, wherein a shunting resistance is connected between the ground electrical connection and at least one of the write shield, the top shield and the bottom shield.

5. The slider according to claim 4, wherein the shunting resistance between the ground electrical connection and either of the bottom shield and the top shield has a resistance value between 10 k Ohm and 10M Ohm.

6. The slider according to claim 4, wherein the shunting resistance between the ground electrical connection and the write shield has a resistance value less than 10 Ohm.

7. The slider according to claim 4, wherein the shunting resistance between the ground electrical connection and either of the bottom shield and the top shield has a resistance value of 2M Ohm.

8. A hard disk drive for adjusting flying height of a slider, comprising:
a storage medium; and
the slider including a slider substrate having an air bearing surface configured to face the storage medium, a top shield and a bottom shield sandwiching a read sensor, and a write shield,
wherein the slider substrate is electrically connected to a substrate electrical connection which is adapted to provide a flying height control voltage to the slider substrate, whereby the slider substrate and the storage medium form two plates of a capacitor separated by a dielectric layer of air supporting the slider; and
wherein the bottom shield and the write shield both are electrically connected to a ground electrical connection.

9. The hard disk drive according to claim 8, wherein the slider further comprises a heater, one end of the heater is electrically connected to the substrate electrical connection which is adapted to provided a flying height control voltage to the heater, and the other end of the heater is electrically connect to the ground electrical connection.

10. The hard disk drive according to claim 8, wherein the slider further comprises a bottom plate which is electrically connected to the ground electrical connection, and the top shield is electrically connected to the ground electrical connection.

11. The hard disk drive according to claim 10, wherein a shunting resistance is connected between the ground electrical connection and at least one of the write shield, the top shield and the bottom shield.

12. The hard disk drive according to claim 11, wherein the shunting resistance between the ground electrical connection and either of the bottom shield and the top shield has a resistance value between 10 k Ohm and 10M Ohm.

13. The hard disk drive according to claim 11, wherein the shunting resistance between the ground electrical connection and the write shield has a resistance value less than 10 Ohm.

14. The hard disk drive according to claim 11, wherein the shunting resistance between the ground electrical connection and either of the bottom shield and the top shield has a resistance value of 2M Ohm.
